(19) United States
(12) Patent Application Publication
(10) Pub. No.: US 2025/0168750 A1
(43) Pub. Date: May 22, 2025

(54) METHOD OF OPERATING A WIRELESS TELECOMMUNICATIONS NETWORK

(71) Applicant: British Telecommunications Public Limited Company, London, Greater London (GB)

(72) Inventors: Ian NEILD, London, Greater London (GB); Andrew REEVES, London, Greater London (GB)

(21) Appl. No.: 18/729,089

(22) PCT Filed: Jan. 11, 2023
(86) PCT No.: PCT/EP2023/050572

§ 371 Date: Jul. 15, 2024

(30) Foreign Application Priority Data
Feb. 7, 2022 (GB) 2201522.6

(51) Int. Cl. H04W 48/10; H04W 72/0446; H04W 84/12

(52) U.S. Cl. CPC H04W 48/10; H04W 72/0446; H04W 84/12

(57) ABSTRACT

A method of operating a wireless telecommunications network, said network comprising a plurality of User Equipment devices, UEs, a Wireless Access Point, WAP, and a Wireless Local Area Network, WLAN, provided by means of the WAP, the method comprising the steps of: associating, against each of the plurality of UEs, an item of information and a unique timeslot; determining a current time, and from said determination identifying, from the associated timeslots, a timeslot within which the current time coincides; broadcasting, by means of the WAP, for the WLAN, a network identifier comprising the item of information associated with the identified timeslot; identifying, by means of each of the UEs, the broadcast network identifier; and subsequently processing, by means of the UE associated with the identified timeslot, the identified network identifier, such that said UE derives the item of information allocated to said UE.

### FIELD OF INVENTION

The present invention relates to a method of operating a wireless telecommunications network, a telecommunications network, and to components thereof.

### BACKGROUND

Wireless Access Points (WAPs) may facilitate data connectivity between a wide area network (e.g. a fixed-access broadband network) and wireless communication devices (herein also referred to as “User Equipment”, UE).

To do so, WAPs provide Wireless Local Area Networks (WLANs) that work over a radio frequency spectrum with low transmit power, typically providing a range of several meters. For example, the WLAN is available to be based on any one of the IEEE^{RTM} 802.11 family of standards (which form the basis for Wi-Fi^{RTM}).

A UE is available to connect to WLANs provided by the WAP. However, in order for the UE to connect to a WLAN, the UE must first identify the WAP providing the WLAN, as well as identify the WLAN. For example, in the case of a Wi-Fi-based WLAN, a Service Set IDentifier (SSID) may be used to identify a WLAN, in which a WAP will normally publicly broadcast the SSID. When broadcast, these SSIDs can be viewed by all devices in the locality.

A large number of UEs are available to connect to a WAP, and these UEs may be managed by a remote Device Management System (DMS), that is provided as part of: the WAP; the wide area network; and/or a remote device accessible via the wide area network. Such management is in particular desirable for UEs having resource and practical constraints (e.g. battery, physical accessibility, and low compute resources), such as Internet of Things (IoT) devices.

To securely manage a UE remotely, an authenticated connection may be established between a UE and the DMS, via the WLAN. The DMS can then communicate instructions directly, and serially, to each UE via the WLAN. For example, communicating ten different instructions to ten different UEs would require the WAP serially transmitting the ten instructions to each of the UEs, with each transmission occupying radio resources. Given an envisaged increase in the number of UEs requiring management by a DMS, this existing process may suffer, at least, from poor scalability.

It is therefore an aim of the present invention to at least alleviate this aforementioned problem.

### STATEMENTS OF INVENTION

According to a first aspect of the present invention, there is provided: a method of operating a wireless telecommunications network, said network comprising a plurality of User Equipment devices, UEs, a Wireless Access Point, WAP, and a Wireless Local Area Network, WLAN, provided by means of the WAP, the method comprising the steps of: associating (preferably, for the purpose of communication), against each of the plurality of UEs, an item of information and a unique timeslot; determining a current time, and from said determination identifying, from the associated timeslots, a timeslot within which the current time coincides; broadcasting, by means of the WAP, for the WLAN, a network identifier comprising the item of information associated with the identified timeslot; identifying, by means of each of the UEs, the broadcast network identifier; and subsequently processing, by means of the UE associated with the identified timeslot, the identified network identifier, such that said UE derives the item of information allocated to said UE.

According to another aspect of the invention, there is provided a WAP performing time-division multiplexing upon a broadcast network identifier for a WLAN so as to communicate unique items of information to different UEs; and said different UEs performing time-division demultiplexing upon the broadcast network identifiers thereby to retrieve the unique item of information intended for a given UE.

Optionally, there is provided the step of (optionally, the WAP) retrieving a unique identifier for each of the UEs, wherein each item of information is assigned against each unique identifier. Optionally, the unique identifier is a: physical network address of the UE, and may be a Media Access Control (MAC) address. Optionally, each of the UEs are provided as part of a set of at least one UE, and wherein each set is associated with an item of information and a unique timeslot. Optionally, the step of associating, against each of the plurality of UEs, an item of information and a unique timeslot is performed by a device remote from, and in communication with, the WAP. Optionally, there is provided the steps of: determining a subsequent time, after the current time and after the identified timeslot, and from said determination identifying, from the associated timeslots, a subsequent timeslot within which the subsequent time coincides; broadcasting, by means of the WAP, for the WLAN, and at the subsequent time, a subsequent network identifier, different to the network identifier, comprising the item of information associated with the subsequent timeslot; identifying, by means of each of the UEs, the broadcast subsequent network identifier; and subsequently processing, by means of the UE associated with the subsequent timeslot, the identified subsequent network identifier, such that only said UE derives the item of information allocated to said UE.

Preferably, the network identifier is broadcast at, and from, the current time.

According to another aspect, there is provided a method of operating a Wireless Access Point, WAP, in a wireless telecommunications network, said network comprising a plurality of User Equipment devices, UEs, and a Wireless Local Area Network, WLAN, provided by means of the WAP, the method comprising the steps of: receiving an association, against each of the plurality of UEs, with an item of information and a unique timeslot; determining a current time, and from said determination identifying, from the associated timeslots, a timeslot within which the current time coincides; broadcasting, for the WLAN, a network identifier comprising the item of information associated with the identified timeslot, so that the UE associated with the identified timeslot is available to process the identified network identifier so as to derive the item of information allocated to said UE. Preferably, the network identifier is only broadcast for the duration of the identified timeslot.

According to another aspect, there is provided a method of operating User Equipment, UE, in a wireless telecommunications network, said network comprising a plurality of User Equipment, a Wireless Access Point, WAP, and a Wireless Local Area Network, WLAN, provided by means of the WAP, wherein the wireless telecommunications network is configured to associate, for each of the UEs, an item of information and a unique timeslot, and wherein, at a current time coinciding with a timeslot associated with the UE, and to broadcast, by means of the WAP, during the current timeslot and for the WLAN, a network identifier comprising the item of information associated with the identified timeslot and the UE, the method comprising the steps of: identifying the broadcast network identifier; and subsequently processing the identified network identifier, such that the UE derives the item of information allocated to said UE.

Preferably, only the UE associated with the identified timeslot performs the processing, and wherein only said UE derives the item of information.

Preferably, there is provided at least one association of a timeslot with, at least, one of the plurality of UEs to said UE/s, wherein the processing of the identified network identifier is performed only in response to the UE associated with the identified timeslot determining that the current time is within the timeslot associated with said UE. Preferably, providing the association is performed by a communication from the WAP and/or by the, or another, WLAN. Optionally, the communication is performed by means of the, or another, network identifier for the, or another, WLAN. Preferably, there is provided the steps of: the, or each, UE determining the current time; identifying (or retrieving), by a given UE, at least one timeslot associated with said UE; determining, by the given UE, whether the current time is within the at least one retrieved timeslot associated with that given UE; and if the current time is: within said timeslot, said (and, optionally, only said) given UE performing processing of the network identifier thereby to derive (and, optionally, to execute an instruction associated with) the item of information; and not within said timeslot, said given UE performing no action to derive (and/or, optionally, to execute an instruction associated with) the item of information.

Preferably, each item of information associated to each of the UEs (and, optionally, each timeslot) is different; that is, each item of information may be unique amongst the plurality of UEs, and each unique item of information is associated specifically, and only, with a given one of the UEs. Preferably, at least one, or each, item of information is secret.

Preferably, the network identifier comprises the item of information in an encoded form. Preferably, the encoded form is a one-time code. Preferably, the item of information comprises an instruction for the UE/s. Preferably, the instruction is pre-defined or is communicated between the WAP and the plurality of UEs, and still more preferably via the, or another, WLAN. Preferably, the item of information is a unique instruction code (or identifier), which in turn refers to the instruction. Preferably, the instruction is an instruction for a UE not to perform an, or any, action and/or any changes in action.

Preferably, the methods are performed without the, or each, UE connecting, or being connected, to the, or any, WLAN. Optionally, the, or each, UE may be connected to another WLAN, which may be provided by the, or another, WAP. Optionally, at least one of the UEs is unable (optionally, ever) to connect, or forbidden from connecting, to the WLAN. Optionally, at least one of the UEs may connect to the WLAN, preferably having been authenticated by the WAP. Optionally, the WLAN provides no onward data connection the, or each, UE to a wide area network accessible via the WAP.

Preferably, the network identifier is a Service Set Identifier. Optionally, the network identifier only consists of the item of information or a reversible derivative thereof. Optionally, the network identifier comprises a pre-defined code for causing the, or each, UE to perform the processing of the network identifier (and only upon identifying said pre-defined code in the network identifier).

Preferably, there is provided encrypting of the item of information associated with the identified timeslot, thereby to generate a ciphertext, wherein the broadcast network identifier comprises said ciphertext, and wherein the UE associated with the identified timeslot performing processing of the network identifier comprises said UE decrypting the network identifier thereby to derive the item of information.

Optionally, the decryption is performed using a decryption key common to all of the plurality of UEs. Optionally, the decryption is performed using a decryption key that is unique to the, or each, UE. Optionally, all of the UEs attempt the processing of the identified network identifier, which may be done using by each UE using the decryption key associated therewith.

According to another aspect of the invention, there is provided a computer-readable carrier medium comprising a computer program, which, when the computer program is executed by a computer, causes the computer to carry out the steps of any one of the methods described above.

According to another aspect of the invention, there is provided a wireless telecommunications network comprising: a plurality of User Equipment devices, UEs, each comprising a controller; a Wireless Access Point, WAP, comprising: a wireless transceiver; a Wireless Local Area Network, WLAN, provided by means of the wireless transceiver; at least one processor configured to: associate, against each of the plurality of UEs, an item of information and a unique timeslot; determine a current time, and from said determination identify, from the associated timeslots, a timeslot within which the current time coincides; and wherein: the wireless transceiver is configured to broadcast, during the identified timeslot (optionally, including during the current time), for the WLAN, a network identifier comprising the item of information associated with the identified timeslot; each controller is configured to identify, the broadcast network identifier; and the controller of the UE associated with the identified timeslot is configured to process the identified network identifier, such that said UE derives the item of information allocated to said UE. Preferably, the at least one processor forms part of the WAP and/or the device remote from, and in communication with, the WAP.

According to another aspect of the invention, there is provided a Wireless Access Point, WAP, comprising: a wireless transceiver for communicating with a plurality of User Equipment devices, UEs, over a Wireless Local Area Network, WLAN, provided by means of the WAP; a receiver for receiving an association, against each of the plurality of UEs, with an item of information and a unique timeslot; a processor configured to: determining a current time, and from said determination identifying, from the associated timeslots, a timeslot within which the current time coincides; and wherein the wireless transceiver is configured to broadcast, during the identified timeslot and for the WLAN, a network identifier comprising the item of information associated with the identified timeslot, so that the UE associated with the identified timeslot is available to process the identified network identifier so as to derive the item of information allocated to said UE.

Optionally, the receiver forms part of the processor, such that the processor generates the associations.

According to another aspect of the invention, there is provided User Equipment, UE, for operating within a wireless telecommunications network, said network comprising a plurality of UEs, a Wireless Access Point, WAP, and a Wireless Local Area Network, WLAN, provided by means of the WAP, wherein the wireless telecommunications network is configured to associate, for each of the UEs, an item of information and a unique timeslot, and wherein, at a current time coinciding with a timeslot associated with the UE, and to broadcast, by means of the WAP, during the current timeslot and for the WLAN, a network identifier comprising the item of information associated with the identified timeslot, the UE comprising: a controller for: identifying the broadcast network identifier; and processing the identified network identifier, such that the UE derives the item of information allocated to said UE.

As used herein, the term “User Equipment” is preferably not to be construed as being limited to usage in relation to cellular telecommunications, and may include any wireless network-enabled client device.

Optionally, the item of information comprises an ASCII symbol or is an ASCII string, and wherein the ASCII string is a password or access credentials, and for example for accessing the wireless telecommunications network, and specifically for accessing another WLAN.

Optionally, at least two of the timeslots are different as to duration. Optionally, the duration of a timeslot is selected in dependence upon the associated: UE; and/or item of information, and particular in dependence on a priority level of the item of information. Preferably, each of the timeslots are non-overlapping. Optionally, at least two of the timeslots are consecutive. Optionally, at least two of the timeslots are sequential and comprise an intervening period comprising no timeslot, wherein during said intervening period: the network identifier ceases to be broadcast; no network identifier is broadcast for the WLAN and/or by the WAP; the network identifier is replaced by another network identifier comprising no associated item of information; and/or (as appropriate); no processing is performed by any of the UEs so as to, or attempt to, derive the associated item of information. Optionally, a plurality of the timeslots are associated with at least one of the UEs, and wherein the items of information in turn associated with each of said plurality of timeslots may be the same or different. Preferably, each timeslot and/or intervening period is: at least or up to 1 day; at least or up to 1 hour; at least or up to 1 minute; at least or up to 1 second; at least or up to 500 ms; at least or up to 250 ms; at least or up to 100 ms; at least or up to 50 ms; at least or up to 25 ms; or at least or up to 10 ms. Preferably, the network identifier is broadcast for the entirety of the timeslot, and more preferably no longer.

The invention includes any novel aspects described and/or illustrated herein. The invention also extends to methods and/or apparatus substantially as herein described and/or as illustrated with reference to the accompanying drawings. The invention is also provided as a computer program and/or a computer program product for carrying out any of the methods described herein and/or for embodying any of the apparatus features described herein, and a computer-readable medium storing thereon a program for carrying out any of the methods and/or for embodying any of the apparatus features described herein. Features described as being implemented in hardware may alternatively be implemented in software, and vice versa.

Any apparatus feature may also be provided as a corresponding step of a method, and vice versa. As used herein, means plus function features may alternatively be expressed in terms of their corresponding structure, for example as a suitably-programmed processor.

Any feature in one aspect of the invention may be applied, in any appropriate combination, to other aspects of the invention. Any, some and/or all features in one aspect can be applied to any, some and/or all features in any other aspect, in any appropriate combination. Particular combinations of the various features described and defined in any aspects of the invention can be implemented and/or supplied and/or used independently.

As used throughout, the word ‘or’ can be interpreted in the exclusive and/or inclusive sense, unless otherwise specified.

The invention extends to a method of operating a wireless telecommunications network, a method of operating a Wireless Access Point, a method of operating User Equipment, User Equipment, a Wireless Access Point, and a wireless telecommunications network, as described herein and/or substantially as illustrated with reference to the accompanying drawings. The present invention is now described, purely by way of example, with reference to the accompanying diagrammatic drawings, in which:

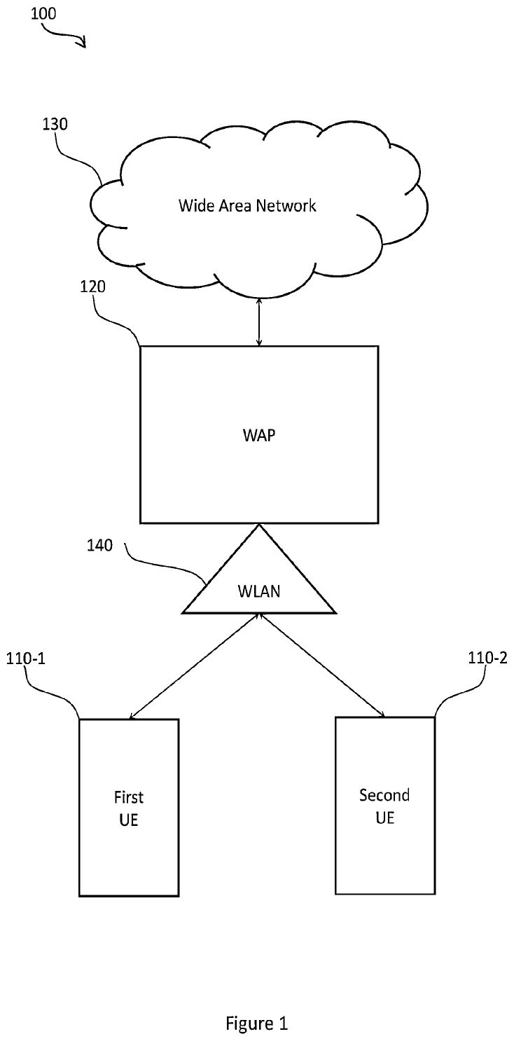

FIG. 1 is a schematic diagram of an exemplary wireless telecommunications network;

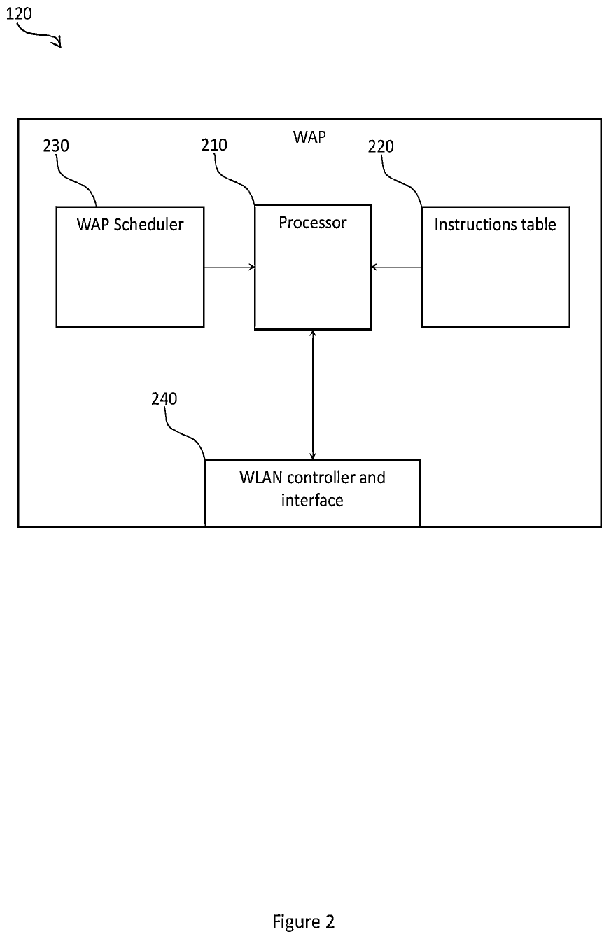

FIG. 2 is a schematic diagram of a Wireless Access Point of the wireless telecommunications network;

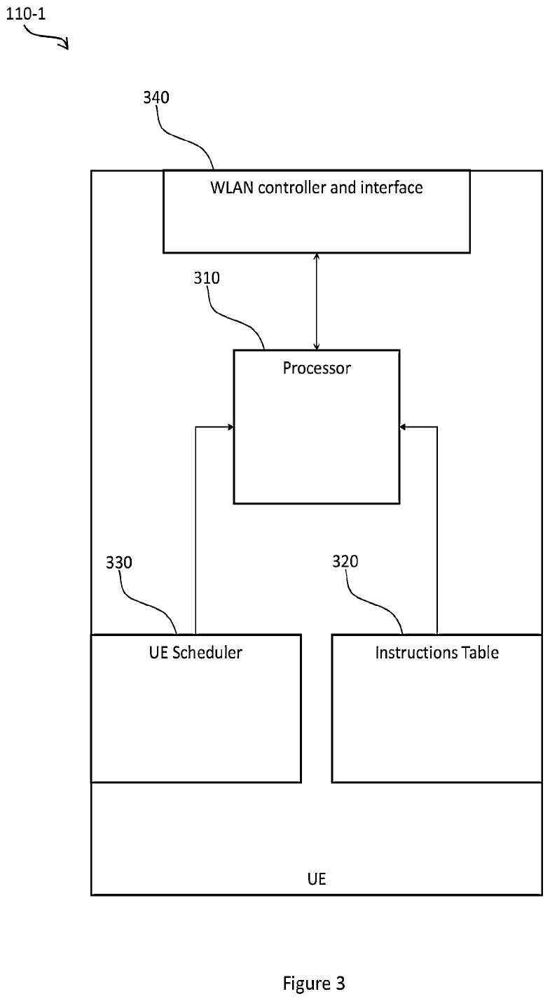

FIG. 3 is a schematic diagram of a User Equipment device of the wireless telecommunications network; and

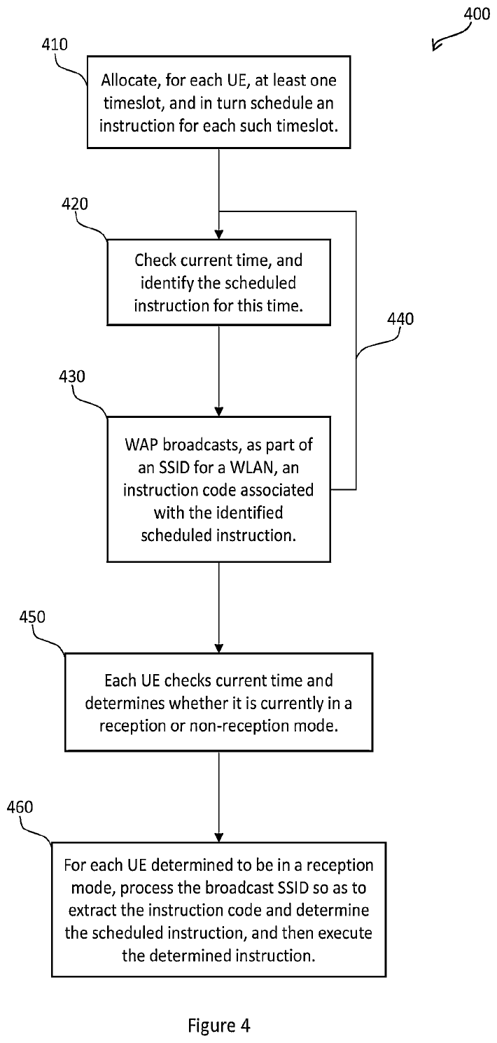

FIG. 4 shows a process for operating the wireless telecommunications network.

### SPECIFIC DESCRIPTION

FIG. 1 shows an exemplary wireless telecommunications network 100, which comprises: a set of a plurality of wireless telecommunication devices (or User Equipment devices, UEs) 110; a Wireless Access Point (WAP) 120; and a wide area network 130.

The WAP 120 is configured to generate a Wireless Local Area Network (WLAN) 140, to which each of the UEs 110 is available to connect.

In one example, the WAP is a wireless router, gateway, edge device, extender and/or repeater, and the WLAN is available to operate based on any of the IEEE^{RTM} 802.11 family of standards. The UEs are available to be in the form of any electronic communications device incorporating a WLAN interface, and in particular a/an: personal computer (laptop or desktop); mobile telecommunications device; Internet of Things (IoT) device; wireless repeater; and/or wireless extender.

The WAP 120 is connected (e.g. via an Ethernet connection) to the wide area network 130, which comprises, for example, a fixed-access broadband network and/or a cellular network. As a result, the UE 110 is available to connect, via the WLAN 140, to the wide area network 130, and in turn to, for example, the Internet.

The WAP 120 is configured to broadcast a network identifier that identifies the WLAN 140 to the UEs 110; this network identifier is in the form of a Service Set IDentification (SSID), which is a configurable text-based identifier. The length of each individual SSID is defined by standards. Typically, an SSID can consist of up to 32 ASCII characters (alphanumeric, case-sensitive characters from the set of 256 ASCII characters, with some restrictions on the first character).

As shown in the example of FIG. 2, the number of UEs in the set 110 is two, which are all located sufficiently proximate to the WAP 120 so as to be within wireless range of the WAP, and therefore the WLAN 140 is detectable and identifiable to the UEs.

In more detail, and with reference to FIG. 2, the WAP 120 comprises a/an: processor 210; WAP instructions table 220; WAP Scheduler 230; and WLAN controller and interface 240.

The instructions table 220 provides a one-to-one association between a UE-executable instruction and a unique instruction code. An exemplary instructions table is provided in Table 1, as follows:

TABLE 1

| UE-executable instruction | Instruction Code |
|---|---|
| No instructions | 000000 |
| Reboot | a51caDTve |
| Update | Update |
| Sleep | 531282 |
| Reset network configurations | #5?P32 |
| First UE to record a timeslot at 00:15:00 | UE1_TS_00:15:00 |

As in example shown in Table 1, an instruction code is available to be a plaintext version of the intended instruction (e.g. “Update” for an update) or, alternatively, a code known to the UEs and WAP (e.g. “a51caDTve” for a reboot), with the latter form adding an extra layer of security.

The WAP Scheduler 230 comprises a: clock; and a schedule.

The schedule comprises a timetable that associates a unique identifier (discoverable by the WAP, and for example a Media Access Control address) of each of the UEs 110, a timeslot associated with each UE, and an intended instruction (from the WAP instructions table 220) for each UE. An exemplary (optionally, non-exhaustive) schedule is provided in Table 2, as follows:

TABLE 2

| UE Unique | | Timeslot | | Instruction |
|---|---|---|---|---|
| Identifier | Timeslot | identifier | Instruction | Code |
| ED-0F-CD-82-24-7F | 00:00:00-00:00:50 | 1 | Reboot | a51caDTve |
| 40-D5-A1-99-DE-28 | 00:01:00-00:01:50 | 2 | Sleep | 531282 |
| ED-0F-CD-82-24-7F | 00:02:00-00:02:50 | 3 | Reset network | #5?P32 |
| | | | configurations | |
| 40-D5-A1-99-DE-28 | 00:03:00-00:03:50 | 4 | No instructions | 000000 |
| ED-0F-CD-82-24-7F | 00:04:00-00:04:50 | 5 | Update | Update |
| 40-D5-A1-99-DE-28 | 00:05:00-00:05:50 | 6 | No instructions | 000000 |
| ED-0F-CD-82-24-7F | 00:06:00-00:06:50 | 7 | Reboot | a51caDTve |
| 40-D5-A1-99-DE-28 | 00:07:00-00:07:50 | 8 | No instructions | 000000 |

In Table 2, the first and second UEs are associated with the unique (MAC) identifiers “ED-OF-CD-82-24-7F” and “40-D5-A1-99-DE-28”, respectively. The timeslot is a dedicated period for communication with an intended (associated) UE; this period is denoted by two time bounds shown in 24-hour clock notation (format hh:mm:ss). At least for ease of reference throughout, each timeslot has been provided in Table 2 with a numerical timeslot identifier (i.e. 1 to 8).

For example, the first UE 110-1 is allocated a timeslot between midnight and 50 seconds past midnight (timeslot 1); in turn, an instruction is allocated for this timeslot and for this UE to ‘Reboot’.

The WLAN controller and interface 240 comprises a communication interface for establishing the WLAN 140, as well as a controller for controlling operation of said interface, and in particular for configuring, and causing broadcasting of, the network address of the WLAN.

The processor 210 is in communication with the WAP instructions table 220, WAP Scheduler 230, and the WLAN controller and interface 240 (comprising, at least, a wireless transceiver).

In more detail, and with reference to FIG. 3, the first UE comprises a/an: processor 310; UE instructions table 320; UE Scheduler 230; and WLAN controller and interface 340.

The UE instructions table 320 comprises all or part of the WAP Instructions table 220. Accordingly, to the extent that each UE and the WAP comprise the same mappings between instructions and instruction codes, intended instructions may be communicated to the UEs by means of appropriate instruction codes.

The UE Scheduler 330 comprises a clock and a schedule corresponding, at least in part, to the schedule of the WAP Scheduler 230. In particular, the schedule of the first UE 110-1 comprises at least the timeslots associated with the first UE 110-1 (e.g. with reference to Table 2, timeslots 1, 3, 5 and 7).

The clocks of the WAP 120 and the first UE 110-1 are synchronised (e.g. via a network timing signal) within a tolerable margin of error.

The WLAN controller and interface 340 comprises a communication interface for utilising the WLAN 140, and in particular for detecting the network identifier of the WLAN and for transmitting the unique identifier associated with the first UE, as well as a controller for controlling operation of said interface.

When, by means of the UE Scheduler 330 (and specifically using the associated clock), the first UE 110-1 determines that the current time falls within a timeslot allocated to that UE (using the UE Scheduler, and specifically the associated schedule), then the UE enter an execution mode, in which the processor 310 is configured to perform processing of a broadcast SSID detected by the WLAN controller and interface 340 so as to interpret that SSID (or a part thereof) as a communication intended for that UE; at any other time, the UE is in a non-execution mode, in which no such processing is performed. For example, with reference to Table 2, at a current time of 00:00:30 (i.e. falling within timeslot 1), the first UE 110-1 is in the execution mode.

The second UE 110-2 has a corresponding configuration to the first UE 110-1, with the schedule of the second UE storing at least the timeslots associated with the second UE (e.g. timeslots 2, 4, 6 and 8).

It will be appreciated that the WAP 120 and the UEs 110 comprise further components to those shown in and described with reference to FIGS. 1 to 3, as appropriate, but these further components have been omitted for conciseness.

By means of the aforementioned components, the WAP and UEs are configured to communicate dedicated instructions to individual UEs, via broadcast SSIDs, using a principle of time-division multiplexing and demultiplexing. FIG. 4 shows an exemplary process 400 to address different instructions to each of the UEs 110 in this way.

In a first step 410, instructions (and the corresponding instruction codes) are selected from the WAP instructions table 220 and are allocated against each of the UEs 110 (in association with a unique identifier for each UE, as retrieved by the WAP). For example, the first UE 110-1 is allocated the instruction “Reboot”, and the second UE 110-2 is allocated the instruction “Sleep”.

Also at step 410, timeslots for the WAP and for each UE are compiled and co-ordinated, such that each UE is allocated at least one upcoming timeslot and such that this timeslot is known to both the subject UE and the WAP. In one example, timeslots are predefined or are dynamically instructed by the WAP or negotiated between the WAP and UE (e.g. via a, or the, WLAN). Accordingly, the output of step 410 is a schedule associating each UE with a timeslot, and each timeslot with an instruction, akin to that shown in Table 2.

At a next step 420, the WAP Scheduler 230 performs an assessment of a current time (from the clock of the WAP Scheduler) and then identifies the current timeslot and the instruction scheduled for this timeslot 420.

The identified currently scheduled instruction is communicated to the processor 210, which causes broadcasting of an SSID from which the scheduled instruction is derivable by an intended target UE, only at a time when the intended target UE is in an execution mode and therefore receptive to that instruction (i.e. within the allocated timeslot for the target UE). The WLAN controller and interface 240 then configures the SSID for the WLAN 140 to incorporate (only or at least) the instruction code 430 associated with the currently scheduled instruction. The instruction code is then broadcast by the WAP as part of the SSID for the WLAN 140.

After step 430, a loop 440 back to step 420 allows the WAP Scheduler 230 to continue assessing the current time, and therefore the currently scheduled instruction, and in turn the instruction code that is to be broadcast as an SSID.

In parallel, at step 450, each of the UEs 110 assess themselves as to whether or not they are in an execution mode. For each UE that determines itself to be in an execution mode, then upon detecting the broadcast SSID, each such UE processes the detected SSID so as to extract the instruction code contained therewith using information from the UE Instructions Table 320, and each such UE then decodes the instruction from the extracted instruction code, and upon deriving the instruction, the UE then executes the instruction 460. Where a UE is determined to be in a non-execution mode, such a UE is configured to prevent, at least, execution of the instruction.

Persisting with the example of Table 2, Table 3 below shows an exemplary set of current times, and the SSIDs that are broadcast at each current time, as well as whether or not the first and second UEs are in an execution mode:

TABLE 3

| | | Instruction | | |
|---|---|---|---|---|
| Current | Timeslot | code in | First | Second |
| Time | Identifier | SSID | UE Mode | UE Mode |
| 00:00:15 | 1 | a51caDTve | Execution | Non-execution |
| 00:00:55 | N/A | a51caDTve | Non-execution | Non-execution |
| 00:02:50 | 3 | #5?P32 | Execution | Non-execution |
| 00:05:07 | 6 | 000000 | Non-execution | Execution |
| 00:10:00 | N/A | 000000 | Non-execution | Non-execution |

In this way, SSIDs may be used to communicate different instructions to different intended UEs, thereby alleviating the need to transmit instructions to the UEs via a communication link using data packets over the WLAN 140.

Where the underlying instructions and/or timeslots are secret (i.e. known only to the WAP and appropriate UEs), process 400 may also simultaneously achieve the result of concealing what instructions are being communicated, and/or to which UEs.

### Alternatives and Modifications

In an alternative, the WLAN 140 is only visible to the UEs 110, which are forbidden or unable to connect to the WLAN. In this way, the WLAN merely serves, by means of its SSIDs, to communicate instructions to the UEs, rather than to serve as a conventional wireless data network.

In an alternative, step 410 and/or 420 are performed by a device that is remote from the WAP, and for example a Cloud-based Device Management System (DSM) that is in communication with the WAP via the wide area network. Accordingly, the processor 210; WAP Scheduler 230; and/or WAP Instructions table 220 are available to be provided as part of the remote device instead.

In an alternative, the SSID comprises the instruction code and an appended pre-defined code (e.g. a prefix and/or suffix) indicating to the UEs 110 the presence of an instruction code in the SSID for demultiplexing. Accordingly, for processing efficiency, the UEs, having been preconfigured to identify the appended code, can identify which SSIDs contain an instruction code, and therefore which SSIDs to process according to step 460.

In an alternative, the instruction is instead, more generally, data or information, such as an alphanumeric or an ASCII symbol. As such, process 400 is available to be used to communicate unique information to each UE, such as network access credentials, and for example a password.

Although the example of FIG. 1 shows only two UEs, it will be appreciated that telecommunications network 100 is available to comprise more UEs, in which process 400 is performed so as to communicate unique sets of instruction to all such UEs. Furthermore, in an alternative, the first and/or second UEs is, or are each, instead a set of a plurality of UEs having the same timeslots.

In one example, the instruction codes are available to be converted into an encrypted string for broadcasting as part of the SSID, and the UEs are configured, at step 460, also to decrypt the encrypted string so as to output the instruction code. In one example, encryption keys are common to all UEs 110.

In an alternative, the encryption keys are unique to each UE 110. In this case, a given UE is available to sacrifice having prior knowledge of its allocated timeslot and therefore whether it is in an execution or non-execution mode. As a result, the schedule forming part of the UE scheduler 330 and step 450 are therefore optional, and step 460 is modified so that no condition of a UE being in an execution mode is required for the ensuing processing of an instruction code. Instead, every UE attempts processing of the broadcast SSID by identifying and then decrypting the encrypted string. Where such decryption yields a valid instruction code (i.e. corresponding to an entry in the UE Instruction table), then that UE knows it has successfully identified a command intended for itself.

In an alternative, an upcoming timeslot for a given UE is communicated to that UE by the WAP 140 by means of a SSID, either as: the instruction code, in which said instruction code communicates a timeslot and an instruction for a target UE to record said timeslot as an upcoming timeslot for the target UE; a separate (plaintext, coded or encrypted) commonly-intelligible string within the same SSID containing the instruction code; or as a (plaintext, coded or encrypted) commonly-intelligible string in another broadcast SSID altogether. For example, the string “UE1_00:00:00-UE2_00:01:00” may be contained in a SSID broadcast by the, or another, WAP (prior to timeslot 1), and intelligible to the first and second UEs to record in their respective schedulers 330 configurations according to timeslots 1 and 2 as shown in Table 2, respectively.

Instances may arise where an instruction is unintentionally communicated to an unintended target UE; this may be accidental or done maliciously, for example by SSID spoofing. To help reduce this risk, at least the following actions may be adopted:
1. timeslots are kept to a minimum duration;
2. timeslots are randomly allocated to UEs;
3. timeslots are securely communicated to the WAP and the UEs;
4. during non-execution modes, UEs are configured to monitor any SSIDs that correspond to an instruction code that are being broadcast for a period of time in excess of a threshold value (e.g. where a malicious party is spoofing an instruction-containing SSID in the hope that the spoofed SSID will eventually coincide with a timeslot), and ignores the SSID and any other SSIDs broadcast by the WAP from which that SSID is broadcast; and/or
5. instruction codes are for one-time use, and are burned (i.e. never repeated) after being broadcast and/or processed by a UE.

It will be appreciated that the timeslots can be defined in any appropriate manner beyond that exemplified in Table 2. For example, the times and periods may be defined in absolute (as in Table 2) or relative (e.g. for five seconds after the end of a preceding period) terms. Furthermore, adjacent timeslots may be consecutive (i.e. with no time gap between timeslots for different UEs) or include a gap (e.g. as in Table 2). Any (UE and WAP-perceptible) value is available to be selected as the duration of a timeslot. The number and duration of timeslots, and/or the gaps between adjacent timeslots may be the same or different for different UEs and/or different instructions (e.g. the more important a UE and/or an instruction is, the longer the timeslot, so as to help ensure successful communication, in case of time desynchronisation).

Each feature disclosed herein, and (where appropriate) as part of the claims and drawings may be provided independently or in any appropriate combination.

Any reference numerals appearing in the claims are for illustration only and shall not limit the scope of the claims.

1. A method of operating a wireless telecommunications network, said network comprising a plurality of User Equipment devices, UEs, a Wireless Access Point, WAP, and a Wireless Local Area Network, WLAN, provided by means of the WAP, the method comprising the steps of:
associating, against each of the plurality of UEs, an item of information and a unique timeslot;
determining a current time, and from said determination identifying, from the associated timeslots, a timeslot within which the current time coincides;
broadcasting, by means of the WAP, for the WLAN, a network identifier comprising the item of information associated with the identified timeslot;
identifying, by means of each of the UEs, the broadcast network identifier; and
subsequently
processing, by means of the UE associated with the identified timeslot, the identified network identifier, such that said UE derives the item of information allocated to said UE.

2. A method of operating a Wireless Access Point, WAP, in a wireless telecommunications network, said network comprising a plurality of User Equipment devices, UEs, and a Wireless Local Area Network, WLAN, provided by means of the WAP, the method comprising the steps of:
receiving associations, against each of the plurality of UEs, with an item of information and a unique timeslot;
determining a current time, and from said determination identifying, from the associated timeslots, a timeslot within which the current time coincides; and
broadcasting, for the WLAN, a network identifier comprising the item of information associated with the identified timeslot, so that the UE associated with the identified timeslot is available to process the identified network identifier so as to derive the item of information allocated to said UE.

3. A method of operating User Equipment, UE, in a wireless telecommunications network, said network comprising a plurality of User Equipment, a Wireless Access Point, WAP, and a Wireless Local Area Network, WLAN, provided by means of the WAP, wherein the wireless telecommunications network is configured to associate, for each of the UEs, an item of information and a unique timeslot, and, at a current time coinciding with a timeslot associated with the UE, to broadcast, by means of the WAP, during the current timeslot and for the WLAN, a network identifier comprising the item of information associated with the identified timeslot and the UE, the method comprising the steps of:
identifying the broadcast network identifier; and subsequently processing the identified network identifier, such that the UE derives the item of information allocated to said UE.

4. A method according to claim 1, wherein only the UE associated with the identified timeslot performs the processing, and wherein only said UE derives the item of information.

5. A method according to claim 1, further comprising:
providing at least one association of a timeslot with, at least, one of the plurality of UEs to said UE/s, wherein the processing of the identified network identifier is performed only in response to the UE associated with the identified timeslot determining that the current time is within the timeslot associated with said UE.

6. A method according to claim 1, wherein each item of information associated with each of the UEs is different.

7. A method according to claim 1, wherein the network identifier comprises the item of information in an encoded form.

8. A method according to claim 7, wherein the encoded form is a one-time code.

9. A method according to claim 1, wherein the item of information comprises an instruction for the UE/s.

10. A method according to claim 1, wherein the method is performed without the, or each, UE connecting, or being connected, to the, or any, WLAN.

11. A method according to claim 1, wherein the network identifier is a Service Set Identifier.

12. A method according to claim 1, further comprising:
encrypting the item of information associated with the identified timeslot, thereby to generate a ciphertext, wherein the broadcast network identifier comprises said ciphertext, and wherein the UE associated with the identified timeslot performing processing of the network identifier comprises said UE decrypting the network identifier thereby to derive the item of information.

13. A method according to claim 12, wherein the decryption is performed using a decryption key common to all of the plurality of UEs.

14. A method according to claim 12, wherein the decryption is performed using a decryption key that is unique to the, or each, UE.

15. A computer-readable carrier medium comprising a computer program, which, when the computer program is executed by a computer, causes the computer to carry out the steps of claim 1.

16. A wireless telecommunications network comprising:
a plurality of User Equipment devices, UEs, each comprising a controller;
a Wireless Access Point, WAP, comprising a wireless transceiver;
a Wireless Local Area Network, WLAN, provided by the wireless transceiver;
at least one processor configured to:
associate, against each of the plurality of UEs, an item of information and a unique timeslot;
determine a current time, and from said determination identify, from the associated timeslots, a timeslot within which the current time coincides;
and wherein:
the wireless transceiver is configured to broadcast, during the identified timeslot and for the WLAN, a network identifier comprising the item of information associated with the identified timeslot;
each controller is configured to identify, the broadcast network identifier; and
the controller of the UE associated with the identified timeslot is configured to process the identified network identifier, such that said UE derives the item of information allocated to said UE.

17. A Wireless Access Point, WAP, comprising:
a wireless transceiver for communicating with a plurality of User Equipment devices, UEs, over a Wireless Local Area Network, WLAN, provided by means of the WAP;
a receiver for receiving an association, against each of the plurality of UEs, with an item of information and a unique timeslot;
a processor configured to:
determine a current time, and from said determination identify, from the
associated timeslots, a timeslot within which the current time coincides; and wherein the wireless transceiver is configured to broadcast, during the identified timeslot and for the WLAN, a network identifier comprising the item of information associated with the identified timeslot, so that the UE associated with the identified timeslot is available to process the identified network identifier so as to derive the item of information allocated to said UE.

18. User Equipment, UE, for operating within a wireless telecommunications network, said network comprising a plurality of UEs, a Wireless Access Point, WAP, and a Wireless Local Area Network, WLAN, provided by means of the WAP, wherein the wireless telecommunications network is configured to associate, for each of the UEs, an item of information and a unique timeslot, and wherein, at a current time coinciding with a timeslot associated with the UE, and to broadcast, by means of the WAP, during the current timeslot and for the WLAN, a network identifier comprising the item of information associated with the identified timeslot, the UE comprising:
a controller for:
identifying the broadcast network identifier; and
processing the identified network identifier, such that the UE derives the item of information allocated to said UE.
